(19) United States
(12) Patent Application Publication
(10) Pub. No.: US 2011/0179704 A1
(43) Pub. Date: Jul. 28, 2011

(54) Synthetic natural-appearing plant supports

(76) Inventor: Beth Louise MacFarlane, Cambria, CA (US)

(21) Appl. No.: 12/657,499

(22) Filed: Jan. 22, 2010

(51) Int. Cl. A01G 17/14

(52) U.S. Cl. 47/47

(57) ABSTRACT

The objective is to produce height adjustable plant & floral supports that require no fasteners, do not harm the plant, appear to be a natural part of the plant, enhance the look of the plant and/or floral arrangement and are made of a synthetic material which is resistant to weather, moisture, infestation and disease.

### BACKGROUND OF THE INVENTION

1. Field of Invention

This invention relates to plant and floral bouquet supports shaped like natural twigs.

2. Background of the Invention

Plants commonly need some type of support in order to prevent injury to the plant often caused by weather and/or unruly growth. Plants and floral bouquets often need support to maintain integrity of design.

There are many products available to the gardener and florist to deal with these issues:
Stakes that support, when the plant stem is tied to them, often caused plant damage and an unnatural looking result, especially if several stems are tied to the same stake.
Decorative stakes, often brightly colored and made of medal, are unnatural in appearance and vary greatly in support capabilities.
Wife cage-like frames which are placed around the plant, those again are unnatural in appearance.

This invention relates to a natural appearing twig-shaped plant support device that is constructed in one piece, comprised of a stem with arms. The stem of the twig-shaped device goes into the plant soil next to the plant needing support.

The twig-shaped device allows plant stems to lean into the “Y” of the support in such a way that the use of ties will be unnecessary. The usual way of supporting plant stems is with a straight stake and a tie. Ties can and often do injure the plant, especially those plants with delicate stems. The twig-shaped device is designed to look natural, i.e., to look like part of the plant, so as to make it difficult to detect.

The size of these devices may vary to accommodate different applications and plant sizes (short, tall, thin or thick). The number of twig arms may also vary. The colors and shapes will be natural, with the goal being to blend in with the hues and shapes in nature.

### DRAWING DESCRIPTION

FIG. 1 is a front view of a plant support having a vertical support member having one end tapered (1) to go into the ground and multiple arms (2) notched at (5) for easy height adjustment. The plurality of arms (2) is angled upwardly from a plurality of positions on the vertical support. The “Y” (3) is formed between the vertical support and each arm (2).

FIG. 2 is a side view of FIG. 1 showing the vertical support and the arms all being in a single plane (4).

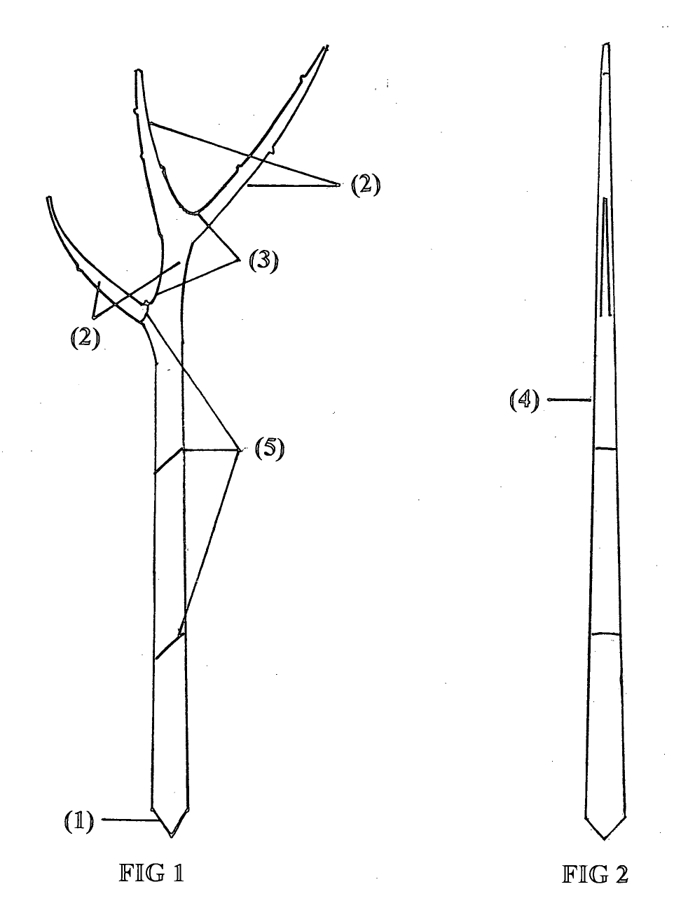

What is claimed:

1. A plant support comprising:
a vertical support member having one end tapered to go into the ground adjacent to a plant to be supported;
at least two arms attached to the vertical support member at different positions along its length;
each arm angled upwardly to form a Y shape with the vertical member for supporting the plant, one Y being higher than the other Y, either of which can support the adjacent plant; and
the vertical support and the arms all being in a single plane.
